(19) United States
(12) Patent Application Publication
(10) Pub. No.: US 2019/0166914 A1
(43) Pub. Date: Jun. 6, 2019

(54) ELECTRONIC CIGARETTE AND TEMPERATURE WARNING METHOD THEREOF

(71) Applicant: Joyetech Europe Holding GmbH, Zug (CH)

(72) Inventor: Weihua QIU, Changzhou (CN)

(21) Appl. No.: 16/251,900

(22) Filed: Jan. 18, 2019

Related U.S. Application Data
(63) Continuation-in-part of application No. PCT/CN2017/093234, filed on Jul. 17, 2017.

(30) Foreign Application Priority Data
Jul. 19, 2016 (CN) 201610571333.9
Jul. 19, 2016 (CN) 201610571435.0
Jul. 19, 2016 (CN) 201620763821.5

(51) Int. Cl. A24F 47/00; G01K 1/02

(52) U.S. Cl. CPC A24F 47/008; G01K 1/02

(57) ABSTRACT

An electronic cigarette includes an electric locking device. When the atomizing assembly is energized, the electric locking device locks the cover; when the atomizing assembly is powered off and stops working, the electric locking device unlocks the cover. Or, the electronic cigarette includes a memory switch, when the temperature of the memory switch is greater than or equal to the transition temperature, the memory switch locks the cover. When the temperature of the memory switch is less than transition temperature, the memory switch unlocks the cover, thus improving the safety of the electronic cigarette.

### CROSS-REFERENCE TO RELATED APPLICATIONS

This application is a continuation in part of International Patent Application No. PCT/CN2017/093234, filed on Jul. 17, 2017, entitled “electronic cigarette and temperature warning method thereof”, which claims priority to Chinese Patent Application No. 201610571435.0, filed on Jul. 19, 2016; No. 201620763821.5, filed on Jul. 19, 2016; No. 201610571333.9, filed on Jul. 19, 2016. All of the aforementioned patent applications are hereby incorporated by reference in their entireties.

### FIELD

The present disclosure relates to the technical field of electronic cigarette, in particular to an improved electronic cigarette and a temperature warning method thereof.

### BACKGROUND

A conventional baking type electronic cigarette is provided with an atomizing chamber therein. The atomizing chamber is provided with a heating cup for loading and heating solid smoke substrate such as tobacco shred, tobacco paste or the like. The electronic cigarette is further provided with a cover for opening or closing the atomizing chamber through a buckle structure. However, after long-term use, the buckle structure may be mechanically worn, resulting in the cover cannot be to securely close the atomizing chamber during use. Once the cover is loosened or mis-opened due to the mechanical wear of the buckle structure during use, the high temperature component (eg, the heating cup) in the atomizing chamber is exposed, thereby may cause accidental burns to the user.

On the other hand, some of the components of the atomizing chamber (e.g., heating cup) requires cleaning after use. Since the temperature of the atomizing chamber is high during use, after the user stops inhaling, if the user clean the electronic cigarette without knowing whether the temperature of the component to be cleaned falls to the safe temperature or below the safe temperature, it may cause burns.

### SUMMARY

The object of the present disclosure is to provide an electronic cigarette having a safety protection function.

An electronic cigarette includes a main housing, an atomizing assembly located in the main housing; and a cover attached to the atomizing assembly, the electronic cigarette further includes an electric locking device located between the main housing and the cover, and a control circuit board, when the atomizing assembly is energized, the control circuit board controls the locking member to lock the cover; when the atomizing assembly is powered off, the control circuit board controls the locking member to unlock the cover.

In one embodiment, the main housing is provided with a electric locking device mounting groove, the electric locking device is an electric plug lock, the electric locking device includes a locking body and a locking member disposed at the locking body, the locking tongue can extend out of the lock body and can also be retracted from the outer side of the lock body into the lock body, the lock body is mounted in the electric locking device mounting groove, the cover defines a locking hole for the locking member to be inserted into or withdrawn therefrom to lock or unlock the cover.

In one embodiment, the top surface of the main housing is provided with an atomizing component installation groove for mounting the atomizing assembly, the electric locking device mounting groove is located adjacent to the atomizing component installation groove, the atomizing component installation groove includes a first groove and a second groove located above the first groove, two opposite sides of the second groove extends through the corresponding opposite sides of the main housing, an arcuate groove is laterally opened along the main housing on the inner wall of the another opposite sides of the groove top section, the locking hole is defined at bottom surface of the cover, the locking member is inserted into or withdrawn from the locking hole along a vertical direction of the main housing.

In one embodiment, the cover includes a cover plate and a projection protruding from the bottom surface of the cover plate, the atomizing assembly includes a heating component, the heating component is located in the first groove of the atomizing component installation groove, the outer circumference of the projection is provided with a latch.

In one embodiment, the upper surface of the cover plate is provided with a smoke guiding passage corresponding to the position of the projection, the smoke guiding passage extends through the projection.

In one embodiment, the atomizing assembly includes a heating component, a filter screen, and a sealing ring, the filter screen is located in the atomizing component installation groove, a third groove is provided at the junction of the first groove and the second groove, the sealing ring is received in the third groove.

In one embodiment, the electric locking device further includes a locking cover, the locking cover is provided with a through hole for the locking member to pass through, the lock cover is located at the opening of the top end of the electric locking device mounting groove.

In one embodiment, when the cover is covered on the atomizing assembly, the peripheral side of the cover is at least partially embedded in the main housing, the locking hole is defined on one side surface of the cover, the locking member can be inserted into or withdrawn from the locking hole laterally along the main housing.

In one embodiment, the electric locking device is an electromagnetic lock, the electromagnetic lock includes an electromagnet and a magnetic member, the main housing is provided with an electric locking device mounting groove, the cover is provided with a locking hole, the electromagnet is mounted in the electric locking device mounting groove, the magnetic member is located in the locking hole.

In one embodiment, the electronic cigarette further includes a battery cover, an inner bracket and a battery, a mounting window is defined at one side of the main housing, one side of the inner mounting bracket away from the mounting window is configured for mounting the control circuit board, the opposite side of the inner mounting bracket is provided with a battery compartment, the battery is received in the battery compartment, the battery cover is releasably covered on the mounting window.

The beneficial effects of the device are:

The electronic cigarette of the disclosure has an electric locking device. In use, the locking member of the electric locking device protrudes into the corresponding locking hole of the cover or attracts the magnetic member through the electromagnet of the electric locking device, so that the cover cannot be opened and locked. After use, the locking member of the electric locking device is retracted, the magnetic attraction of the electromagnet disappears, and then the cover can be opened, thereby improving the safety of the use of the electronic cigarette.

The disclosure further provides an electronic cigarette and a temperature warning method thereof, which can monitor the temperature of the component to be cleaned in the atomizing chamber after the user has finished inhaling, and prevent the user from causing burns when the temperature does not fall to a safe temperature or below.

An electronic cigarette includes a main housing, an atomizing assembly located in the main housing, and a cover attached to the atomizing assembly, the electronic cigarette further includes an electric locking device and/or alarm device, a temperature sensor and a control circuit board, the atomizing assembly includes a component need to be cleaned, the temperature sensor is disposed on or adjacent to the component to be cleaned for detecting the temperature of the component to be cleaned and fed back to the control circuit board, the control circuit board is pre-stored with a safe temperature, the control circuit board is also used to determine the relationship between the safe temperature and the temperature of the component to be cleaned, and controlling the action of the electric lock device and/or the alarm device according to the judgment result;

when the temperature of the component to be cleaned is greater than the safe temperature, the control circuit board controls the alarm device to issue an alarm and/or the control circuit board controls the electric locking device to lock the cover;

when the temperature of the component to be cleaned is less than or equal to the safe temperature, the control circuit board controls the alarm device to release the alarm and/or the control circuit board controls the electric locking device to unlock the cover.

In one embodiment, the heating component is a heating cup, the temperature sensor is mounted on the bottom surface of the heating cup.

In one embodiment, the electric locking device is an electric plug lock, the electric locking device includes a locking body and a locking member disposed at the locking body, the locking tongue can extend out of the lock body and can also be retracted from the outer side of the lock body into the lock body, the cover defines a locking hole for the locking member to be inserted into or withdrawn therefrom to lock or unlock the cover.

In one embodiment, the top surface of the main housing is provided with an atomizing component installation groove for mounting the atomizing assembly, the atomizing component installation groove includes a first groove and a second groove located above the first groove two opposite sides of the second groove extends through the corresponding opposite sides of the main housing, an arcuate groove is laterally opened along the main housing on the inner wall of the another opposite sides of the groove top section, the locking hole is defined at bottom surface of the cover, the locking member is inserted into or withdrawn from the locking hole along a vertical direction of the main housing.

In one embodiment, the cover includes a cover plate and a projection protruding from the bottom surface of the cover plate, the outer circumference of the projection is provided with a latch, the upper surface of the cover plate is provided with a smoke guiding passage corresponding to the position of the projection, the smoke guiding passage extends through the projection, the atomizing assembly includes a filter screen, the filter screen is located in the atomizing component installation groove.

In one embodiment, when the cover is covered on the atomizing assembly, the peripheral side of the cover is at least partially embedded in the main housing, the locking hole is defined on one side surface of the cover, the locking member can be inserted into or withdrawn from the locking hole laterally along the main housing.

In one embodiment, the electric locking device is an electromagnetic lock, the electromagnetic lock includes an electromagnet and a magnetic member, the main housing is provided with an electric locking device mounting groove, the cover is provided with a locking hole, the electromagnet is mounted in the electric locking device mounting groove, the magnetic member is located in the locking hole.

In one embodiment, the alarm device is selected from at least one of a warning light, a voice device, a buzzer device, and a display device.

The present disclosure also provides another electronic cigarette.

An electronic cigarette includes a main housing, an atomizing assembly located in the main housing and a cover attached to the atomizing assembly, the electronic cigarette further includes an electric locking device and/or alarm device, a temperature sensor, and a control circuit board, the atomizing assembly includes a heating component, the heating portion of the heating component is made of a material having a temperature coefficient of resistance characteristic, the control circuit board pre-stores the safe temperature, a correspondence table between the resistance of the heating portion and the temperature of the heating component, the control circuit board is configured for detecting the resistance of the heating portion, and calculating the temperature of the heating component according to the correspondence relationship between the resistance of the heating portion and the temperature of the heating component, the control circuit board is also configured to determine the relationship between the temperature of the heating component and the safe temperature, and controlling the action of the electric lock device and/or the alarm device according to the judgment result;

when the temperature of the component to be cleaned is greater than the safe temperature, the control circuit board controls the alarm device to issue an alarm and/or the control circuit board controls the electric locking device to lock the cover;

When the temperature of the component to be cleaned is less than or equal to the safe temperature, the control circuit board controls the alarm device to release the alarm and/or the control circuit board controls the electric locking device to unlock the cover.

In one embodiment, the electric locking device is an electric plug lock, the electric locking device includes a locking body and a locking member disposed at the locking body, the locking tongue can extend out of the lock body and can also be retracted from the outer side of the lock body into the lock body, the cover defines a locking hole for the locking member to be inserted into or withdrawn therefrom to lock or unlock the cover.

In one embodiment, the electric locking device is an electromagnetic lock, the electromagnetic lock includes an electromagnet and a magnetic member, the main housing is provided with an electric locking device mounting groove, the cover is provided with a locking hole, the electromagnet is mounted in the electric locking device mounting groove, the magnetic member is located in the locking hole.

In one embodiment, the alarm device is selected from at least one of a warning light, a voice device, a buzzer device, and a display device.

The present disclosure also provides a temperature warning method for an electronic cigarette.

A temperature warning method of an electronic cigarette, the electronic cigarette includes a main housing, an atomizing assembly located in the main housing, a cover attached to the atomizing assembly, an electric locking device and/or alarm device, a temperature sensor and a control circuit board pre-stored with a safe temperature, the atomizing assembly includes a component need to be cleaned, the temperature warning method includes:

the temperature sensor detects the temperature of the component to be cleaned, and feeds back the temperature of the component to be cleaned to the control circuit board;

the control circuit board determines the relationship between the temperature of the component to be cleaned and the safe temperature;

when the temperature of the component to be cleaned is greater than the safe temperature, the control circuit board controls the alarm device to issue an alarm and/or the control circuit board controls the electric locking device to lock the cover;

when the temperature of the component to be cleaned is less than or equal to the safe temperature, the control circuit board controls the alarm device to release the alarm and/or the control circuit board controls the electric locking device to unlock the cover.

In one embodiment, the electric locking device is an electric plug lock, the electric locking device is located in the main housing, the electric locking device includes a locking body and a locking member, the cover defines a locking hole,

When the temperature of the component to be cleaned is greater than the safe temperature, the control circuit board controls the locking member to extend out and be inserted into the locking hole, and then the cover is locked. When the temperature of the component to be cleaned is less than or equal to the safe temperature, the control circuit board controls the locking member to exit the locking hole, and then the cover is unlocked.

In one embodiment, the electric locking device is an electromagnetic lock, the electromagnetic lock includes an electromagnet and a magnetic member, the electromagnet and the magnetic member are respectively mounted on the main housing and the cover, the electronic cigarette further includes a battery, the electromagnet is electrically connected to the battery;

when the temperature of the component to be cleaned is greater than the safe temperature, the control circuit board controls the circuit between the electromagnet and the battery to be turned on, the electromagnet generates magnetic attraction to attract the magnetic member, and then the cover is locked;

when the temperature of the component to be cleaned is less than or equal to the safe temperature, the control circuit board controls the circuit between the electromagnet and the battery to be disconnected, the magnetic attraction of the electromagnet disappears, and then the cover is unlocked.

The present disclosure also provides another temperature warning method for an electronic cigarette.

A temperature warning method of an electronic cigarette, the electronic cigarette includes a main housing, an atomizing assembly located in the main housing, a cover attached to the atomizing assembly, an electric locking device and/or alarm device, a temperature sensor and a control circuit board pre-stored with a safe temperature, the temperature warning method includes:

the control circuit board detects the resistance of the heating portion of the heating component;

the control circuit board calculates the temperature of the heating component based on the correspondence relationship between the resistance of the heating portion and the temperature of the heating component;

the control circuit board determines the relationship between the temperature of the heating component and the safe temperature;

when the temperature of the component to be cleaned is greater than the safe temperature, the control circuit board controls the alarm device to issue an alarm and/or the control circuit board controls the electric locking device to lock the cover;

when the temperature of the component to be cleaned is less than or equal to the safe temperature, the control circuit board controls the alarm device to clear the alarm and/or the control circuit board controls the electric locking device to unlock the cover.

In one embodiment, the electric locking device is an electric plug lock, the electric locking device is located in the main housing, the electric locking device includes a locking body and a locking member, the cover defines a locking hole,

when the temperature of the component to be cleaned is greater than the safe temperature, the control circuit board controls the locking member to extend out and be inserted into the locking hole, and then the cover is locked. When the temperature of the component to be cleaned is less than or equal to the safe temperature, the control circuit board controls the locking member to exit the locking hole, and then the cover is unlocked.

In one embodiment, the electric locking device is an electromagnetic lock, the electromagnetic lock includes an electromagnet and a magnetic member, the electromagnet and the magnetic member are respectively mounted on the main housing and the cover, the electronic cigarette further includes a battery, the electromagnet is electrically connected to the battery;

when the temperature of the component to be cleaned is greater than the safe temperature, the control circuit board controls the circuit between the electromagnet and the battery to be turned on, the electromagnet generates magnetic attraction to attract the magnetic member, and then the cover is locked;

when the temperature of the component to be cleaned is less than or equal to the safe temperature, the control circuit board controls the circuit between the electromagnet and the battery to be disconnected, the magnetic attraction of the electromagnet disappears, and then the cover is unlocked.

The beneficial effects of the device are:

After the user inhales, the temperature information is transmitted to the control circuit board through the temperature sensor, or the control circuit board calculates the heating component through the resistance of the heating portion of the heating component. Thus, the temperature of the component to be cleaned in the atomizing chamber can be monitored in real time, preventing the user from scalding when the temperature above the safe temperature.

The invention also provides an electronic cigarette which cannot be opened when the temperature in the atomization chamber is greater than the safe temperature, thereby improving the safety of use.

An electronic cigarette includes a main housing, an atomizing assembly located in the main housing and a cover attached to the atomizing assembly, the electronic cigarette further includes a memory switch disposed between the main housing and the cover, the action of the memory switch is according to the temperature conducted by the atomizing assembly to lock the cover on the main housing or release the cover from the main housing.

In one embodiment, the top surface of the main housing is provided with a mounting groove, The mounting groove has a stepped groove structure including a first groove and a second groove, the heating component is located in the first groove, an assembly gap formed between the upper end of the heating component and the inner side wall of the second groove, and a stepped surface formed between the second groove and the first groove is configured for mounting the memory switch.

In one embodiment, the top outer peripheral side of the second groove extends upwardly to form a covered edge, the cover includes a cover plate and a projection protruding from the bottom surface of the cover plate, the projection is inserted in the covered edge.

In one embodiment, the memory switch ‘includes a body and a locking member disposed on the body, the body is located on the stepped surface between the second groove and the first groove, the locking member protrudes from the assembly gap between the upper end of the heating component and the inner side wall of the second groove.

In one embodiment, the memory switches' includes two locking members, The outer peripheral surface of the projection adjacent to the lower surface of the projection defines a receiving groove along the lateral direction of the cover, the bottom surface of the receiving groove is provided with a locking hole extending through the lower surface of the projection, for the locking member to extend through, according to the conducted temperature of the heating component, the locking members are flared outwardly to a maximum distance between the two locking members that is greater than the aperture of the locking hole to lock the cover, or the locking members are contracted inwardly to a maximum distance between the two locking members that is less than or equal to the aperture of the locking hole to unlock the cover.

In one embodiment, the heating component is a heating cup, the inner cavity of the heating cup forms an atomizing chamber, the main housing is provided with an air intake hole not shown, an air inlet in communication with the air intake hole is defined in the bottom surface of the bottom portion, the bottom surface of the heating cup is provided with at least one ventilation hole, the ventilation hole is in communication with the air inlet.

In one embodiment, the bottom surface of the heating cup further extends toward the bottom surface of the first groove with a support frame, the heating cup is supported by the support frame on the bottom surface of the first groove, an air gap is formed between the bottom surface of the heating cup and the bottom surface of the first groove.

In one embodiment, the upper surface of the cover plate is provided with a smoke guiding passage corresponding to the position of the projection, the bottom end of the smoke guiding passage passes through the projection and is in communication with the heating component.

In one embodiment, the atomizing assembly includes a filter screen, the filter screen is located in the smoke guiding passage.

In one embodiment, the electronic cigarette further includes a battery cover, an inner bracket and a battery, a mounting window is defined at one side of the main housing, one side of the inner mounting bracket away from the mounting window is configured for mounting the control circuit board, the opposite side of the inner mounting bracket is provided with a battery compartment, the battery is received in the battery compartment, the battery cover is releasably covered on the mounting window.

The beneficial effects of the device are:

A memory switch is disposed between the cover of the electronic cigarette and the main housing. When the temperature of the memory switch rises to a transition temperature (room temperature<transition temperature≤safe temperature) or above the transition temperature, the locking member of the memory switch is locked with the locking hole corresponding to the cover, and then the cover cannot be opened. After use, the temperature of the memory switch drops below the transition temperature, the locking member is restored to the original shape and can be released from the locking hole, and then the cover can be opened, thus improving the safety of the use of electronic cigarettes.

### BRIEF DESCRIPTION OF THE DRAWINGS

FIG. 1 is a schematic view of an electronic cigarette of the first embodiment.

FIG. 2 is an exploded view of the electronic cigarette shown in FIG. 1.

FIG. 3 is a cross-sectional view of the open state of the electronic cigarette shown in FIG. 1.

FIG. 4 is a cross-sectional view showing the locked state of the electronic cigarette shown in FIG. 1.

FIG. 5 is a cross-sectional view of the second embodiment of the electronic cigarette.

FIG. 6 is a flow chart of a temperature warning method for the electronic cigarette of the third embodiment.

FIG. 7 is a flow chart of another temperature warning method for the electronic cigarette of the third embodiment.

FIG. 8 is a schematic structural view of an electronic cigarette of the fourth embodiment.

FIG. 9 is an exploded view of the electronic cigarette shown in FIG. 8.

FIG. 10 is a cross-sectional view showing the open state of the electronic cigarette shown in FIG. 8;

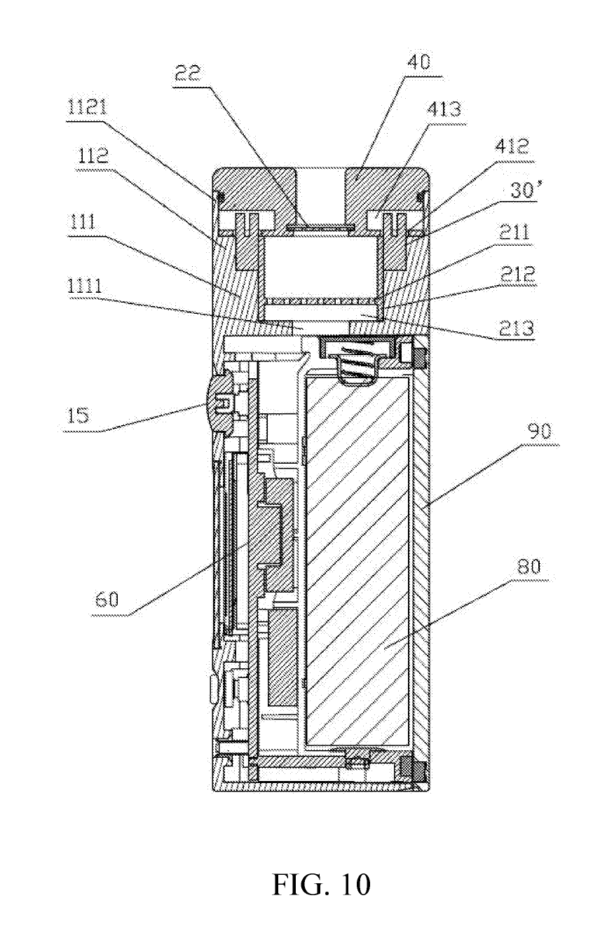

FIG. 11 is a cross-sectional view showing the locked state of the electronic cigarette shown in FIG. 8.

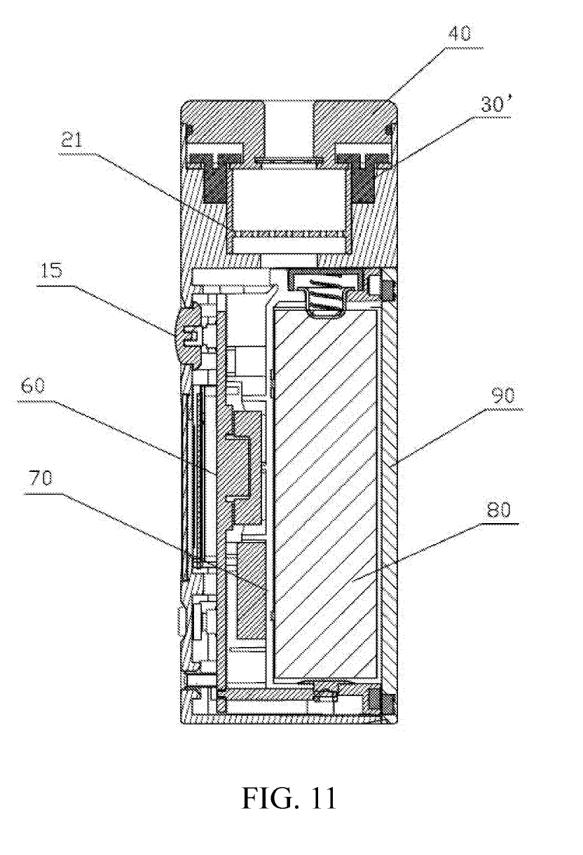

The following table list various components and reference numerals thereof.

| | |
|---|---|
| Locking hole 412 | Filter 22 |
| Main housing 10 | Sealing ring 23 |
| Atomizing component installation | Electric locking device 30 |
| groove 11 | |
| Electric locking device mounting | Locking body 31 |
| groove 12 | |
| Mounting window 13 | Locking member 32 |
| Atomizing assembly 20 | Locking cover 33 |
| Heating component 21 | Electromagnet 34 |
| Mounting groove 17 | Button hole 18 |
| Blocking member 37 | Main body 36 |
| Magnetic member 35 | Battery compartment 71 |
| cover 40 | Battery 80 |
| Cover plate 41 | Battery cover 90 |
| Projection 42 | First groove 111 |
| Temperature sensor 50 | Second groove 112 |
| Control board 60 | Sealing groove 113 |
| Inner mounting bracket 70 | Smoke guiding passage 411 |
| Memory switch 30′ | |

### DETAILED DESCRIPTION OF PREFERRED EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

When a feature or element is herein referred to as being “on” another feature or element, it can be directly on the other feature or element or intervening features and/or elements may also be present.

Terminology used herein is for the purpose of describing particular embodiments only and is not intended to be limiting of the disclosure. As used herein, the term “and/or” includes any and all combinations of one or more of the associated listed items and may be abbreviated as “/”.

### The First Embodiment

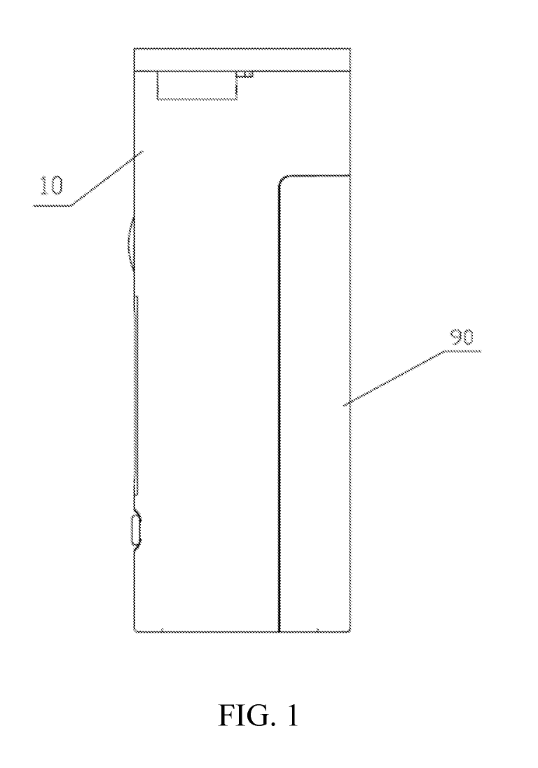

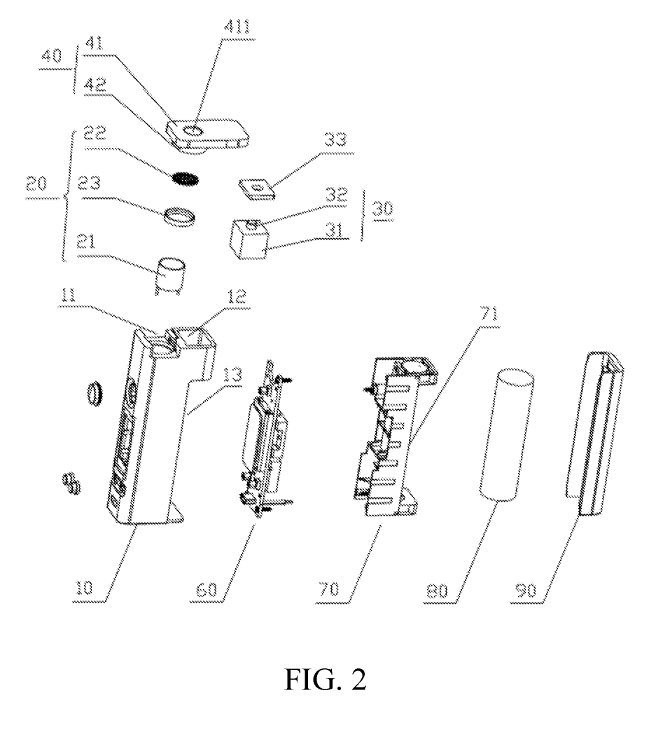

Referring to FIG. 1 and FIG. 2, the present disclosure provides an electronic cigarette, the electronic cigarette includes a main housing 10, an atomizing assembly 20 located in the main housing 10, a cover 40 attached to the atomizing assembly 20, and a locking device located between the main housing 10 and the cover 40. The cover 40 is releasably covered on the atomizing assembly 20 through the locking device. In the embodiment, the locking device is an electric locking device 30. In the embodiment, the cover 40 is a top cover, it can be appreciated that, in other embodiments, the cover 40 can be a side cover or a bottom cover.

The top surface of the main housing 10 is provided with an atomizing component installation groove 11 and a electric locking device mounting groove 12. The atomizing component installation groove 11 is configured for mounting the atomizing assembly 20 and engages with the cover 40. In the embodiment, the atomizing component installation groove 11 includes a first groove 111 and a second groove 112 located above the first groove 111. The first groove 111 has a cylindrical shape for mounting a heating component 21 of the atomizing assembly 20. The second groove 112 is an opening with a rectangular shape, two opposite sides of the opening extend through the corresponding opposite sides of the main housing 10, the cover 40 is at least partially received in the second groove 112. Further, a sealing groove 113 is provided at the junction of the first groove 111 and the second groove 112. That is, the sealing groove 113 communicates between the first groove 111 and the second groove 112. The electric locking device mounting groove 12 is located adjacent to the atomizing component installation groove 11 and is isolated from the atomizing component installation groove 11 for mounting the electric locking device 30. In the embodiment, the electric locking device mounting groove 12 is a rectangular groove.

The atomizing assembly 20 includes a heating component 21, a filter 22, and a sealing ring 23. The heating component 21 is located in the first groove 111 of the atomizing component installation groove 11, the inner cavity of the heating component 21 forms an atomizing chamber. In one embodiment, the heating component 21 is a heating cup. The filter 22 is located at the top end of the atomizing component installation groove 11. The filter 22 can allow smoke to pass there through, and also can prevent the tobacco contained in the heating component 21 from falling. In the embodiment, the filter 22 is located in the smoke guiding passage 411 of the cover 40 corresponding to the package portion of the atomizing component installation groove 11. The sealing ring 23 is received in the sealing groove 113 to enhance the airtightness of the smoke guiding passage 411 through which the smoke flows from the atomizing chamber to the cover 40.

The electric locking device 30 is received in the electric locking device mounting groove 12 for locking the cover 40. The electric locking device 30 is an electric plug lock and includes a locking body 31 and a locking member 32 disposed at the top end of the locking body 31. The locking tongue 32 can extend out of the locking body 31 and can also be retracted from the outer side of the locking body 31 into the locking body 31. Further, the electric locking device 30 further includes a locking cover 33. The locking cover 33 is provided with a through hole for the locking member 32 to pass through. The locking cover 33 is located at the opening of the top end of the electric locking device mounting groove 12, the locking body 31 is held in the electric locking device mounting groove 12.

The cover 40 includes a cover plate 41 and a projection 42 protruding from the bottom surface of the cover plate 41. The upper surface of the cover plate 41 is provided with a smoke guiding passage 411 corresponding to the projection 42, the bottom of the smoke guiding passage 411 passes through the projection 42 and is in communication with the heating component 21. A locking hole 412 is defined in the lower surface of the cover plate 41. The locking hole 412 cooperates with the locking member 32 for the locking member 32 to be inserted into or withdrawn therefrom, so that the cover 40 is locked or unlocked. The projection 42 is located in the second groove 112 of the atomizing component installation groove 11, such that the smoke in the atomizing chamber can flow into the smoke guiding passage 411 of the cover 40.

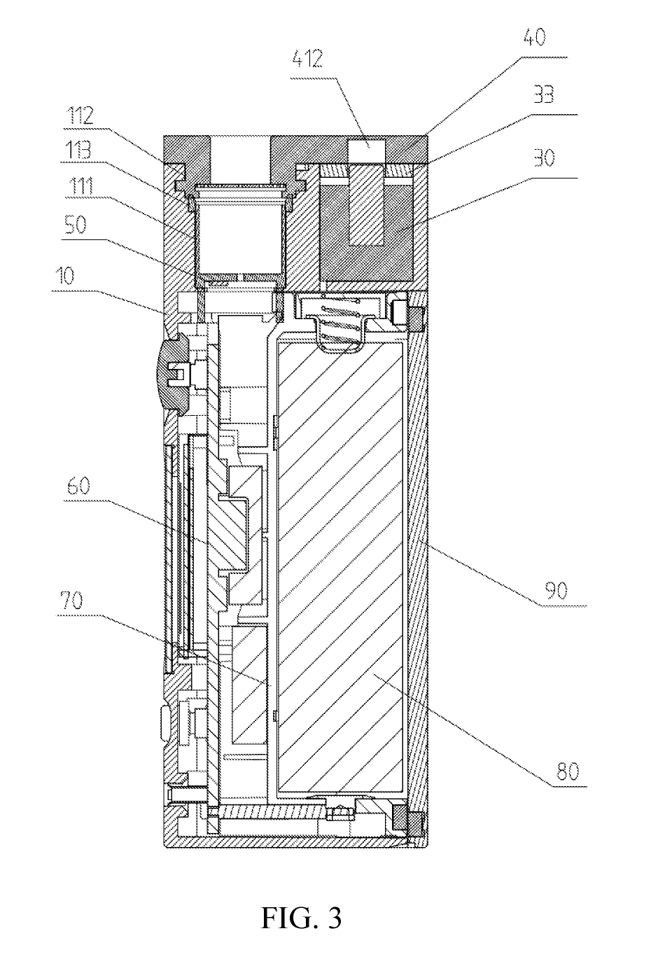

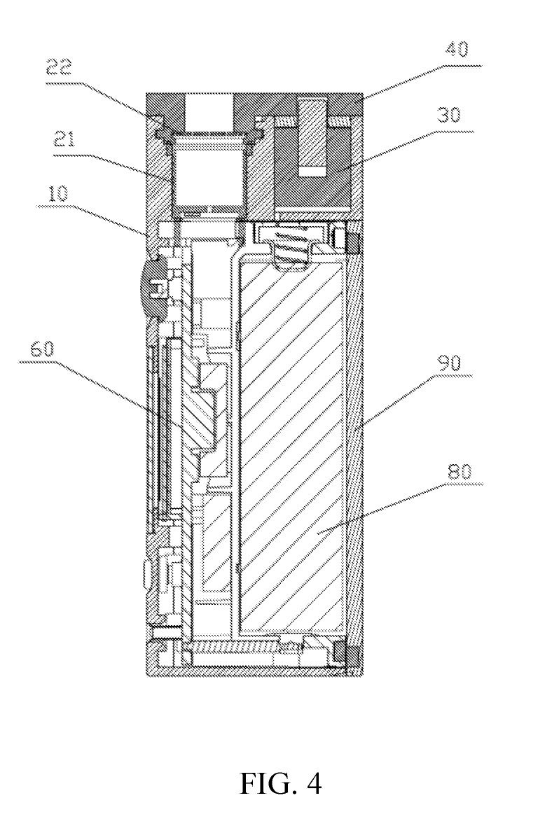

Referring to FIG. 3 and FIG. 4, in the embodiment, an arcuate groove laterally along the main housing 10 is defined on the inner wall of the second groove 112 of the atomizing component installation groove 11. The outer circumference of the projection 42 is provided with a latch (having elasticity) corresponding to the s to arcuate groove. The locking member 32 can be vertically inserted into or withdrawn from the locking hole 412. When the locking member 32 is inserted into the locking hole 412, the cover 40 cannot move laterally along the main housing 10, the latch engages with the arcuate groove to prevent the cover 40 from moving vertically along the main housing 10, whereby the cover 40 is locked. When the locking member 32 is withdrawn from the locking hole 412, the cover 40 can be laterally moved along the main housing 10, and further, the latch can be disengaged from the arcuate groove, whereby the cover 40 can be opened.

It can be understood that, in other embodiments, the electric locking device 30 can also make the cover 40 releasably covered on the atomizing assembly 20 by other means. For example, when the cover 40 is covered on the atomizing assembly 20, the peripheral side of the cover 40 is at least partially embedded in the main housing 10, the locking hole 412 is defined on one side surface of the cover plate 41, the locking member 32 can be inserted into or withdrawn from the locking hole 412 laterally along the main housing 10. When the locking member 32 is inserted into the locking hole 412, the cover 40 is prevented from being vertically movable along the main housing 10 by the locking member 32, and since the peripheral side of the cover 40 is at least partially embedded in the main housing 10, the cover 40 is also unable to move laterally along the main housing 10, whereby the cover 40 is locked. When the locking member 32 is withdrawn from the locking hole 412, the cover 40 can be vertically movable along the main housing 10, whereby the cover 40 can be opened.

The electronic cigarette further includes a control circuit board 60, an inner bracket 70, a battery 80, and a battery cover 90. A mounting window 13 is defined at one side of the main housing 10 for mounting the control circuit board 60, the inner mounting bracket 70, and the battery 80 into the inner cavity of the main housing 10. One side of the inner mounting bracket 70 away from the mounting window 13 is configured for mounting the control circuit board 60, the opposite side is provided with a battery compartment 71 for receiving the battery 80. The battery cover 90 is releasably covered on the mounting window 13 of the main housing 10, correspondingly covers the battery compartment 71, and fixing the battery 80. In addition, two or more button holes or panel holes are formed at the side of the main housing 10 opposite to the mounting window 13 for mounting a button or a display panel. A button such as a cigarette light button or a power adjustment button can be mounted in the button hole. In one embodiment, the cigarette light button directly controls the cigarette light circuit of the control circuit board 60 to be turned on/off, so that the circuit between the heating component 21 and the battery 80 is turned on/off.

To lock or unlock the electric locking device 30 is depended on whether the atomizing assembly 20 is in an operational state or not. Specifically, when the atomizing assembly 20 is energized, that is, when the circuit between the heating component 21 and the battery 80 is turned on, the control circuit board 60 controls the locking member 32 to extend through and is inserted into the locking hole 412, whereby the cover 40 is locked. When the atomizing assembly 20 is powered off, that is, when the circuit between the heating component 21 and the battery 80 is disconnected, the control circuit board 60 controls the locking member 32 to exit the locking hole 412, whereby the cover 40 is unlocked. In this way, the cover 40 can be effectively prevented from being loosened or erroneously opened when the atomizing assembly 20 is in use, thereby preventing the high temperature component (e.g., the heating component 21) from being exposed and scalding the user.

In addition, in order to facilitate the stable installation of the filter 22 in the smoke guiding passage 411, one end of the smoke guiding passage 411 adjacent to the projection 42 defines a stepped groove for mounting the filter 22.

The embodiment further provides a control method of the electronic cigarette:

the control circuit board 60 determines whether the atomizing assembly 20 is energized,

when the atomizing assembly 20 is energized, the control circuit board 60 controls the locking member 32 to extend and be inserted into the locking hole 412, and then the cover 40 is locked;

when the atomizing assembly 20 is powered off and stops working, the control circuit board 60 controls the locking member 32 to exit the locking hole 412, and then the cover 40 is unlocked.

### The Second Embodiment

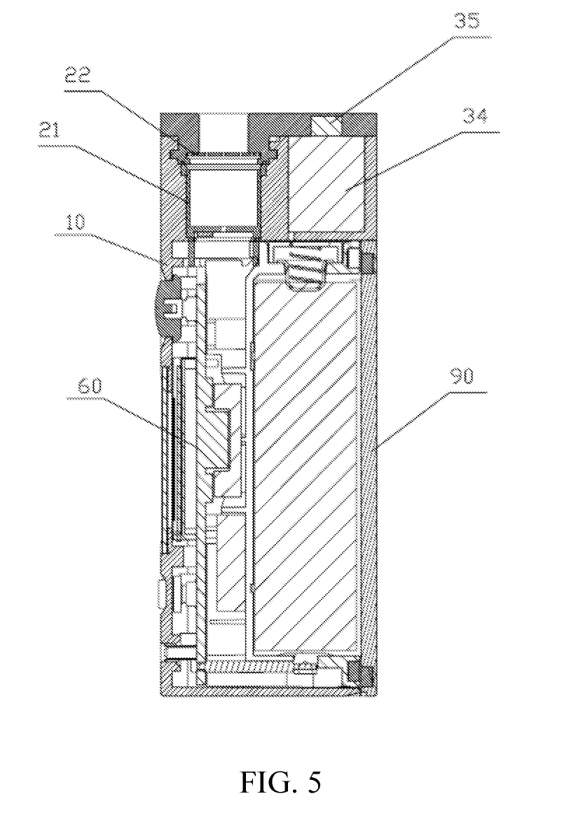

Referring to FIG. 5, the second embodiment provides an electronic cigarette, which is different from the first embodiment in that the electric locking device 30 is an electromagnetic lock, and the electromagnetic lock includes an electromagnet 34 and a magnetic member 35. The electromagnet 34 mounted in the electric locking device mounting groove 12, the magnetic member 35 is mounted in the locking hole 412 of the cover 40.

When the atomizing assembly 20 is energized, that is, when the circuit between the heating component 21 and the battery 80 is turned on, the control circuit board 60 controls the electromagnet 34 to be energized to generate a strong magnetic attraction to attract the magnetic member 35, thereby, the cover 40 is stably mounted on the main housing 10. When the atomizing assembly 20 is powered off and stops working, that is, when the circuit between the heating component 21 and the battery 80 is disconnected, the control circuit board 60 controls the electromagnet to be power off, the magnetic attraction of the electromagnet 34 disappears and the cover 40 can be opened. Thereby, it can effectively prevent the cover 40 from being loosened or erroneously opened when the atomizing assembly 20 is in use; further, the user is prevented from being burnt due to exposure of a high temperature component such as the heating component 21.

The embodiment further provides a control method of the electronic cigarette:

the control circuit board 60 determines whether the atomizing assembly 20 is energized,

when the atomizing assembly 20 is energized, the control circuit board 60 controls the circuit between the electromagnet 34 and the battery 80 to be turned on, the electromagnet 34 generates magnetic attraction to attract the magnetic member 35, and the cover 40 is locked;

when the atomizing assembly 20 is powered off and stops working, the control circuit board 60 controls the circuit between the electromagnet 34 and the battery 80 to be disconnected, the magnetic attraction of the electromagnet 34 disappears, and the cover 40 is unlocked.

In the first embodiment and the second embodiment, the user can directly inhale smoke through the smoke guiding passage 411 on the cover 40 or a cigarette holder suction inserted into the smoke guiding passage 411. In order to prevent the inlet smoke temperature from being too high, a smoke pipe may be disposed between the heating component 21 and the inlet of the smoke guiding passage 411.

### The Third Embodiment

Some of the components of the atomizing assembly 20 of the electronic cigarette described in first embodiment (e.g., the heating component 21) need to be cleaned after use. Since the temperature of the atomizing assembly 20 is high during use, after the user stops inhaling, if the user clean the electronic cigarette without knowing whether the temperature of the component to be cleaned falls to the safe temperature or below the safe temperature, it may cause burns.

Please refer to FIG. 2 and FIG. 3 again, the third embodiment provides another electronic cigarette, which is different from the first embodiment in that the electronic cigarette further includes a temperature sensor 50 for detecting the component to be cleaned in the electronic cigarette. The temperature is fed back to the control circuit board 60, which controls the locking or unlocking of the electric locking device 30 based on the relationship between the temperature of the component to be cleaned and the safe temperature. The safe temperature refers to the temperature at which the user suddenly touches the component need to be cleaned in the electronic cigarette without being burnt. In the embodiment, the safe temperature is 40° C.

Specifically, the temperature sensor 50 is disposed on or adjacent to the component to be cleaned for detecting the temperature of the component to be cleaned and fed back to the control circuit board 60. The control circuit board 60 is pre-stored with the safe temperature. The control circuit board 60 is also used to determine the relationship between the safe temperature and the temperature of the component to be cleaned. When the temperature of the component to be cleaned is greater than the safe temperature, the control circuit board 60 controls the locking member 32 to extend out and be inserted into the locking hole 412, and then the cover 40 is locked. When the temperature of the component to be cleaned is less than or equal to the safe temperature, the control circuit board 60 controls the locking member 32 to exit the locking hole 412, and then the cover 40 is unlocked. Thereby, it can effectively prevent the user from opening the cover 40 without knowing whether the temperature of the component to be cleaned falls to the safe temperature or below the safe temperature, to prevent users from scalding.

It can be understood that, the components to be cleaned having the highest temperature is the heating component 21. Therefore, if the temperature of the heating component 21 has fallen to the safe temperature or below the safe temperature, the temperature of other components to be cleaned (e.g., the filter 22) has also fallen to the safe temperature or below the safe temperature. In this embodiment, the heating component 21 is a heating cup, the temperature sensor 50 is mounted on the bottom surface of the heating cup.

It is to be understood that, in other embodiments, the heating portion of the heating component 21 is made of a material having a temperature coefficient of resistance characteristic, the heating portion may function as a temperature sensing portion. In addition to storing the safe temperature, the control circuit board 60 also stores a correspondence table between the resistance of the heating portion and the temperature of the heating component 21. The control circuit board 60 is configured for detecting the resistance of the heating portion, and calculating the temperature of the heating component 21 according to the correspondence relationship between the resistance of the heating portion and the temperature of the heating component 21. The control circuit board 60 is also used to determine the relationship between the safe temperature and the temperature of the heating component 21. When the temperature of the heating component 21 is higher than the safe temperature, the control circuit board 60 controls the locking member 32 to extend out and is inserted into the locking hole 412, and the topp00 cover 40 is locked. When the temperature of the heating component 21 is less than or equal to the safe temperature, the control circuit board 60 controls the locking member 32 to exit the locking hole 412, and then the cover 40 is unlocked.

It will be appreciated that, in other embodiments, an alarm device may be employed in place of the electric locking device 30. When the temperature of the component to be cleaned is higher than the safe temperature, the control circuit board 60 controls the alarm device to issue an alarm; when the temperature of the component to be cleaned is less than or equal to the safe temperature, the control circuit board 60 controls the alarm device to release alarm. Therefore, it can effectively remind the user whether the temperature of the component to be cleaned is below the safe temperature or the safe temperature. The alarm device may be selected from at least one of a warning light, a voice device, a buzzer device, and a display device. When the alarm device is a warning light, the following alarm mode may be adopted: when the temperature of the component to be cleaned is greater than the safe temperature, the warning light is red; when the temperature of the component to be cleaned is less than or equal to the safe temperature, the warning light is green.

It can be understood that, in other embodiments, the electronic cigarette can include both the electric locking device 30 and the alarm device. Specifically, when the temperature of the component to be cleaned is greater than the safe temperature, the control circuit board 60 controls the locking member 32 to extend out and be inserted into the locking hole 412, and then the cover 40 is locked, and the control circuit board 60 controls the alarm device to issue an alarm. When the temperature of the component to be cleaned is less than or equal to the safe temperature, the control circuit board 60 controls the locking member 32 to exit the locking hole 412, and then the cover 40 is unlocked, and the control circuit board 60 controls the alarm device to clear the alarm.

It can be understood that, in other embodiments, the electric locking device 30 can employ the electromagnetic lock in the second embodiment in addition to the electric plug lock in the first embodiment.

In the cleaning operation, the electric locking device 30 has a safety protection function for the cover 40, the cover 40 can be opened when the temperature of the component to be cleaned is below the safe temperature or equal to the safe temperature. Otherwise, the cover 40 will be locked by the electric locking device 30 and cannot be opened. Alternatively, the safety of opening the cover 40 is reminded by an alarm device, such as by a warning light, a voice device, a buzzer device or a display device. The alarm will be released when the temperature of the component to be cleaned is below the safe temperature or equal to the safe temperature. Alternatively, the safety of opening the cover 40 is simultaneously protected by the electric locking device 30 and the alarm device, when the temperature of the component to be cleaned is above the safe temperature, the alarm device will issue an alarm and the electric locking device 30 locks the cover 40. The temperature of the component to be cleaned is below the safe temperature or equal to the safe temperature, the alarm device clears the alarm and the electric locking device 30 unlocks. In this way, safety during cleaning is greatly improved.

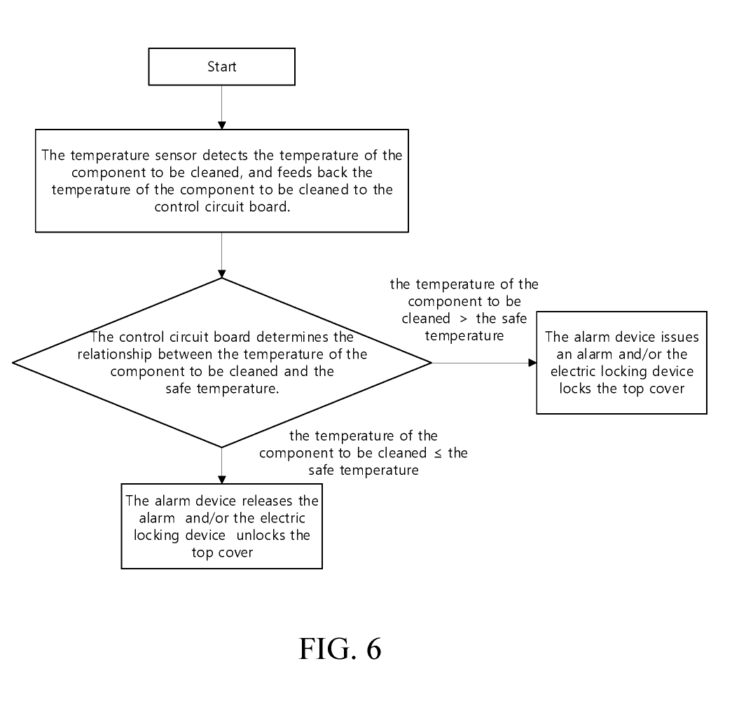

Referring to FIG. 6, when the temperature of the component to be cleaned is detected by the temperature sensor 50, the temperature warning method of the electronic cigarette is as follows:

The temperature sensor 50 detects the temperature of the component to be cleaned, and feeds back the temperature of the component to be cleaned to the control circuit board 60;

The control circuit board 60 determines the relationship between the temperature of the component to be cleaned and the safe temperature;

When the temperature of the component to be cleaned is greater than the safe temperature, the control circuit board 60 controls the alarm device to issue an alarm and/or the control circuit board 60 controls the electric locking device 30 to lock the cover 40;

When the temperature of the component to be cleaned is less than or equal to the safe temperature, the control circuit board 60 controls the alarm device to release the alarm and/or the control circuit board 60 controls the electric locking device 30 to unlock the cover 40.

Further, when the electric locking device 30 is an electric plug lock,

When the temperature of the component to be cleaned is greater than the safe temperature, the control circuit board 60 controls the locking member 32 to extend out and is inserted into the locking hole 412, and then the cover 40 is locked;

When the temperature of the component to be cleaned is less than or equal to the safe temperature, the control circuit board 60 controls the locking member 32 to exit the locking hole 412, and then the cover 40 is unlocked.

Further, when the electric locking device 30 is an electromagnetic lock,

When the temperature of the component to be cleaned is greater than the safe temperature, the control circuit board 60 controls the circuit between the electromagnet 34 and the battery 80 to be turned on, the electromagnet 34 generates magnetic attraction to attract the magnetic member 35, and then the cover 40 is locked;

When the temperature of the component to be cleaned is less than or equal to the safe temperature, the control circuit board 60 controls the circuit between the electromagnet 34 and the battery 80 to be disconnected, the magnetic attraction of the electromagnet 34 disappears, and then the cover 40 is unlocked.

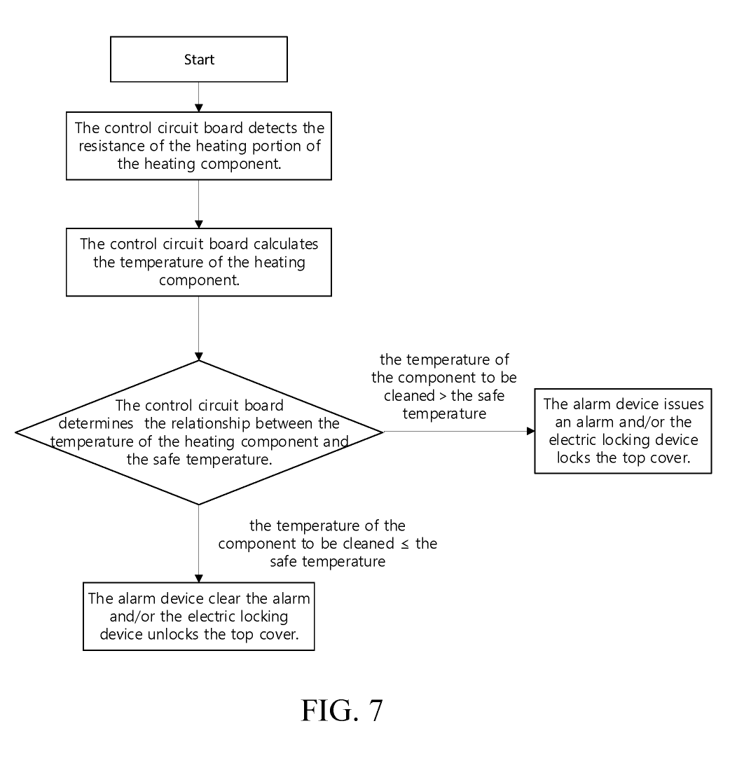

Referring to FIG. 7, when the detected component to be cleaned is the heating component 21 and the heating portion of the heating component 21 is made of a material having a temperature coefficient of resistance characteristic, the temperature warning method of the electronic cigarette is as follows:

The control circuit board 60 detects the resistance of the heating portion of the heating component 21;

The control circuit board 60 calculates the temperature of the heating component 21 based on the correspondence relationship between the resistance of the heating portion and the temperature of the heating component 21;

The control circuit board 60 determines the relationship between the temperature of the heating component 21 and the safe temperature;

When the temperature of the component to be cleaned is greater than the safe temperature, the control circuit board 60 controls the alarm device to issue an alarm and/or the control circuit board 60 controls the electric locking device 30 to lock the cover 40;

When the temperature of the component to be cleaned is less than or equal to the safe temperature, the control circuit board 60 controls the alarm device to clear the alarm and/or the control circuit board 60 controls the electric locking device 30 to unlock the cover 40.

Further, when the electric locking device 30 is an electric plug lock,

When the temperature of the component to be cleaned is greater than the safe temperature, the control circuit board 60 controls the locking member 32 to extend and is inserted into the locking hole 412, and the cover 40 is locked;

When the temperature of the component to be cleaned is less than or equal to the safe temperature, the control circuit board 60 controls the locking member 32 to exit the locking hole 412, and then the cover 40 is unlocked.

Further, when the electric locking device 30 is an electromagnetic lock,

When the temperature of the heating component 21 is greater than the safe temperature, the control circuit board 60 controls the circuit between the electromagnet 34 and the battery 80 to be turned on, the electromagnet 34 generates magnetic attraction to attract the magnetic member 35, and the cover 40 is locked;

When the temperature of the heating component 21 is less than or equal to the safe temperature, the control circuit board 60 controls the circuit between the electromagnet 34 and the battery 80 to be disconnected, the magnetic attraction of the electromagnet 34 disappears, and then the cover 40 is unlocked.

### The Fourth Embodiment

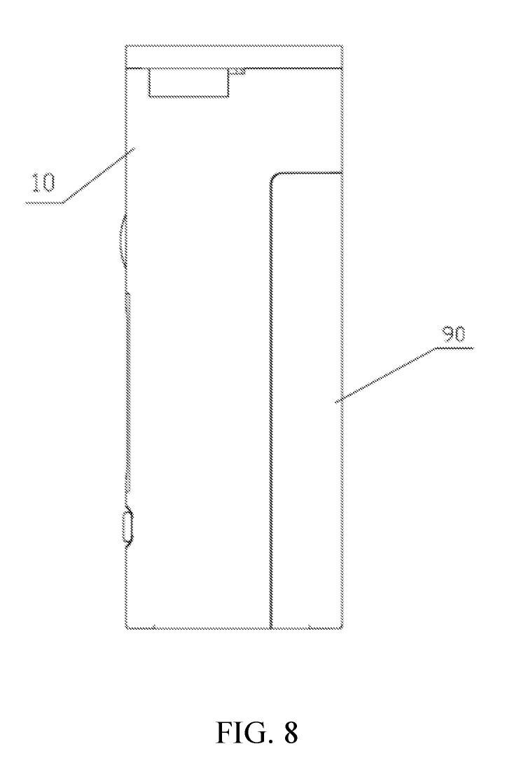

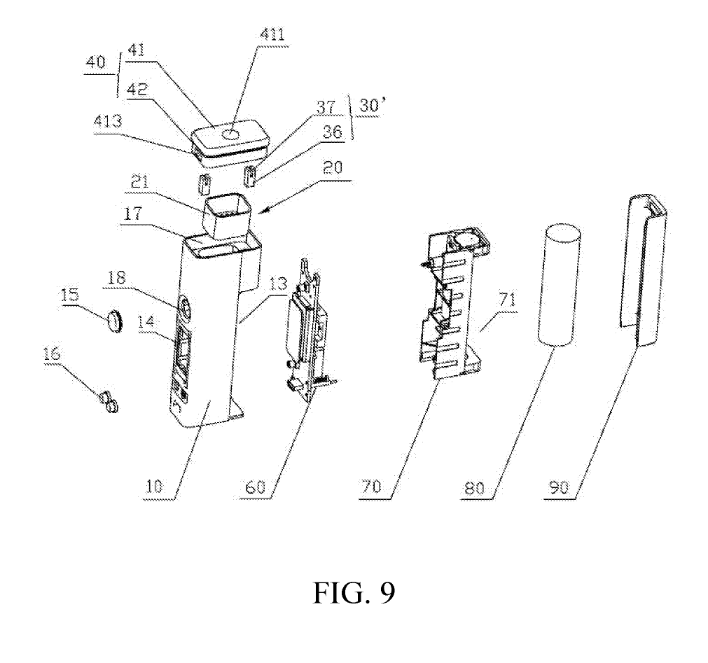

Referring to FIG. 8 and FIG. 9, the present disclosure further provides an electronic cigarette comprising a main housing 10, an atomizing assembly 20 located in the main housing 10, a cover 40 covering the atomizing assembly 20, and a locking device disposed between the main housing 10 and the cover 40. The cover 40 is releasably locked and covered on the atomizing assembly 20 through the locking device. In this embodiment, the locking device is a memory switch 30′.

The top surface of the main housing 10 is provided with a mounting groove 17 for mounting the atomizing assembly 20 and the memory switch 30′, and the mounting groove 17 engages with the cover 40. The mounting groove 17 has a stepped groove structure including a first groove 111 and a second groove 112 (refer to FIG. 3 in combination). The first groove 111 engages with the lower end of the heating component 21 of the atomizing assembly 20 for the lower end of the heating component 21 to be inserted. A stepped surface formed between the second groove 112 and the first groove 111 is configured for mounting the memory switch 30′, such that the memory switch 30′ can be clamped between the inner side surface of the second groove 112 and the outer side of the upper end of the heating component 21, and the direct contact of the memory switch 30′ with the heating component 21 is achieved. In order to accurately and stably mount the cover 40, the top outer peripheral side of the second groove 112 extends upwardly to form a covered edge 1121 for receiving the cover 40.

The atomizing assembly 20 includes a heating component 21 and a filter 22. The heating component 21 is received in the mounting groove 17, the lower end of the heating component 21 is inserted into the first groove 111 of the mounting groove 17. An assembly gap is formed between the upper end of the heating component 21 and the inner side wall of the second groove 112 for mounting the memory switch 30′. The filter 22 is located above the heating component 21 to allow the smoke to pass therethrough while preventing the tobacco contained in the heating component 21 from falling out. In this embodiment, the filter 22 is located in the smoke guiding passage 411, which is corresponding to the packaging end of the mounting groove 17. In the embodiment, the heating component 21 is a heating cup, the inner cavity of the heating cup forms an atomizing chamber, the main housing 10 is provided with an air intake hole (not shown). An air inlet 1111 in communication with the air intake hole is defined in the bottom surface of the first groove 111. The bottom surface of the heating cup is provided with at least one ventilation hole 211. The ventilation hole 211 is in communication with the air inlet 1111. The outside air flows into the inner cavity of the heating cup through the intake hole, the air inlet 1111, and the ventilation hole 211, and carries the smoke out through the opening of the heating cup. The opening is defined in the upper end of the heating cup. Further, the bottom surface of the heating cup further extends toward the bottom surface of the first groove 111 with a support frame 212. The heating cup is supported by the support frame 212 on the bottom surface of the first groove 111, such that an air gap 213 is formed between the bottom surface of the heated cup and the bottom surface of the first groove 111. The air gap 213 is in communication with the air inlet 1111 and the ventilation hole 211 respectively, can effectively prevent the ventilation hole 211 from being shielded by the bottom surface of the first groove 111.

The memory switch 30′ is configured to releasably lock the cover 40. The memory switch 30′ is made of memory alloy material having good thermal conductivity. It is understood that, the component with the highest temperature in the electronic cigarette is the heating component 21, so that the memory switch 30′ is placed close to the heating component 21. As the temperature of the heating component 21 rises, the temperature of the memory switch 30′ also rises. When the temperature of the memory switch 30′ is greater than or equal to the transition temperature, the memory switch 30′ is deformed, and then the cover 40 is locked. When the temperature of the memory switch 30′ is less than the transition temperature, the memory switch 30′ is restored to its original state, and then the cover 40 is unlocked. It can be understood that, the room temperature<the transition temperature of the memory switch 30′≤the safe temperature, the safe temperature refers to a temperature at which the user suddenly contacts an element at a high temperature in the electronic cigarette without being burnt. In the embedment, the safe temperature is 40° C. Thus, when the components in the electronic cigarette are at a high temperature, the cover 40 cannot be opened, the user can be prevented from being burnt. In the embodiment, the memory switch 30′ includes a body 36 and a blocking member 37 disposed on the body 36. The body 36 is located on the stepped surface between the second groove 112 and the first groove 111, the blocking member 37 protrudes from the assembly gap between the upper end of the heating component 21 and the inner side wall of the second groove 112. The number of the memory switches 30′ is two, the two memory switches 30′ are symmetrically arranged along the central axis of the electronic cigarette, each of the memory switches 30′ includes two blocking members 37, which are axially symmetric along the central axis of the body 36. When the temperature of the memory switch 30′ is greater than or equal to the transition temperature, the blocking member 37 is deformed and the cover 40 is locked; when the temperature of the memory switch 30′ is less than the transition temperature, the blocking member 37 is restored and the cover 40 is unlocked.

The cover 40 includes a cover plate 41 and a projection 42 protruding from the bottom surface of the cover plate 41. The upper surface of the cover plate 41 is provided with a smoke guiding passage 411 corresponding to the position of the projection 42, the bottom end of the smoke guiding passage 411 passes through the projection 42 and is in communication with the heating component 21. The projection 42 is embedded in the covered edge 1121, so that the smoke in the atomization chamber flows into the smoke guiding passage 411 of the cover 40. The outer peripheral surface of the projection 42 adjacent to the lower surface of the projection 42 defines a receiving groove 413 along the lateral direction of the cover 40. The bottom surface of the receiving groove 413 is provided with a locking hole 412 extending through the lower surface of the projection 42, for the blocking member 37 to extend through. When the cover 40 is disposed on the atomizing assembly 20, the projection 42 is embedded in the covered edge 1121, so that the movement of the cover 40 in the lateral direction of the electronic cigarette is restricted. When the temperature of the memory switch 30′ is greater than or equal to the transition temperature, two blocking members 37 of the same body 36 are flared outwardly to a maximum distance between the two blocking members 37 that is greater than the aperture of the locking hole 412. When the cover 40 moves vertically upward along the electronic cigarette, the locking hole 412 is resisted by the blocking member 37, whereby the cover 40 is locked. When the temperature of the memory switch 30′ is less than the transition temperature, two blocking members 37 on the same body 36 are contracted inwardly to a maximum distance between the two blocking members 37 that is less than or equal to the aperture of the locking hole 412, and the cover 40 is unlocked. When the smoke moves vertically upward, the locking hole 412 can smoothly pass through the blocking member 37, whereby the cover 40 is unlocked.

The electronic cigarette further includes a control circuit board 60, an inner mounting bracket 70, a battery 80 and a battery cover 90. A mounting window 13 is defined at one side of the main housing 10 for mounting the control circuit board 60, the inner mounting bracket 70, and the battery 80 into the inner cavity of the main housing 10. One side of the inner mounting bracket 70 away from the mounting window 13 is for fixing the control circuit board 60. The opposite side of the inner mounting bracket 70 is provided with a battery compartment 71 for accommodating the battery 80. The battery cover 90 is detachably covered on the mounting window 13 of the main housing 10, the battery compartment 71 is correspondingly covered to secure the battery 80. In addition, a plurality of button holes 18 or panel holes 14 is defined in one side of the main housing 10 opposite to the mounting window 13 for mounting a button or a display panel. The button hole 18 can be assembled with a button therein, such as a cigarette light key 15, a power adjustment key 16, etc., wherein the cigarette light key 15 directly controls the cigarette light circuit of the control circuit board 60 to be turned on/off, so that the circuit between the heating component 21 and the battery 80 is turned On/off.

The locking or unlocking of the memory switch 30′ is determined by the temperature of the memory switch 30′. Specifically, when the atomizing assembly 20 is energized, that is, when the circuit between the heating component 21 and the battery 80 is turned on, the heating component 21 starts to slowly heat up. As the temperature of the heating component 21 rises, when the temperature of the memory switch 30′ abutting the heating component 21 rises to the transition temperature, the blocking member 37 at the top of the memory switch 30′ is opened. After use, as the temperature of the memory switch 30′ drops below the transition temperature, the blocking member 37 of the memory switch 30′ returns to the normal temperature state, at which time the cover 40 can be opened. Thereby, it can effectively prevent the cover 40 from being loosened or erroneously opened, to prevent the user from being burnt by the exposed high temperature component (for example, the heating component 21).

The above-mentioned embodiments merely represent several implementations of the present application, and the descriptions thereof are more specific and detailed, but they shall not be understood as a limitation on the scope of the present application. It should be noted that, for those of ordinary skill in the art, variations and improvements may still be made without departing from the concept of the present application, and all of which shall fall into the protection scope of the present application. Therefore, the scope of protection of the present application shall be subject to the appended claims.

What is claimed is:

1. An electronic cigarette, comprising:
a main housing;
an atomizing assembly located in the main housing; and
a cover attached to the atomizing assembly, wherein
the electronic cigarette further comprises an electric locking device located between the main housing and the cover, and a control circuit board, when the atomizing assembly is energized, the control circuit board controls the locking member to lock the cover;
when the atomizing assembly is powered off, the control circuit board controls the locking member to unlock the cover.

2. The electronic cigarette of claim 1, wherein the main housing is provided with a electric locking device mounting groove, the electric locking device is an electric plug lock, the electric locking device comprises a locking body and a locking member disposed at the locking body, the locking tongue can extend out of the lock body and can also be retracted from the outer side of the lock body into the lock body, the lock body is mounted in the electric locking device mounting groove, the cover defines a locking hole for the locking member to be inserted into or withdrawn therefrom to lock or unlock the cover.

3. The electronic cigarette of claim 2, wherein the top surface of the main housing is provided with an atomizing component installation groove for mounting the atomizing assembly, the electric locking device mounting groove is located adjacent to the atomizing component installation groove, the atomizing component installation groove comprises a first groove and a second groove located above the first groove, two opposite sides of the second groove extends through the corresponding opposite sides of the main housing, an arcuate groove is laterally opened along the main housing on the inner wall of the another opposite sides of the groove top section, the locking hole is defined at bottom surface of the cover, the locking member is inserted into or withdrawn from the locking hole along a vertical direction of the main housing.

4. The electronic cigarette of claim 3, wherein the cover comprises a cover plate and a projection protruding from the bottom surface of the cover plate, the atomizing assembly comprises a heating component, the heating component is located in the first groove of the atomizing component installation groove, the outer circumference of the projection is provided with a latch.

5. The electronic cigarette of claim 4, wherein the upper surface of the cover plate is provided with a smoke guiding passage corresponding to the position of the projection, the smoke guiding passage extends through the projection.

6. The electronic cigarette of claim 5, wherein the atomizing assembly comprises a heating component, a filter screen, and a sealing ring, the filter screen is located in the atomizing component installation groove, a third groove is provided at the junction of the first groove and the second groove, the sealing ring is received in the third groove.

7. The electronic cigarette of claim 2, wherein the electric locking device further comprises a locking cover, the locking cover is provided with a through hole for the locking member to pass through, the lock cover is located at the opening of the top end of the electric locking device mounting groove.

8. The electronic cigarette of claim 2, wherein when the cover is covered on the atomizing assembly, the peripheral side of the cover is at least partially embedded in the main housing, the locking hole is defined on one side surface of the cover, the locking member can be inserted into or withdrawn from the locking hole laterally along the main housing.

9. The electronic cigarette of claim 1, wherein the electric locking device is an electromagnetic lock, the electromagnetic lock comprises an electromagnet and a magnetic member, the main housing is provided with an electric locking device mounting groove, the cover is provided with a locking hole, the electromagnet is mounted in the electric locking device mounting groove, the magnetic member is located in the locking hole.

10. The electronic cigarette of claim 1, wherein the electronic cigarette further comprises a battery cover, an inner bracket and a battery, a mounting window is defined at one side of the main housing, one side of the inner mounting bracket away from the mounting window is configured for mounting the control circuit board, the opposite side of the inner mounting bracket is provided with a battery compartment, the battery is received in the battery compartment, the battery cover is releasably covered on the mounting window.

11. An electronic cigarette, comprising:
a main housing;
an atomizing assembly located in the main housing; and
a cover attached to the atomizing assembly, wherein
the electronic cigarette further comprises an electric locking device and/or alarm device, a temperature sensor and a control circuit board, the atomizing assembly comprises a component need to be cleaned, the temperature sensor is disposed on or adjacent to the component to be cleaned for detecting the temperature of the component to be cleaned and fed back to the control circuit board, the control circuit board is pre-stored with a safe temperature, the control circuit board is also used to determine the relationship between the safe temperature and the temperature of the component to be cleaned, and controlling the action of the electric lock device and/or the alarm device according to the judgment result;
when the temperature of the component to be cleaned is greater than the safe temperature, the control circuit board controls the alarm device to issue an alarm and/or the control circuit board controls the electric locking device to lock the cover;
When the temperature of the component to be cleaned is less than or equal to the safe temperature, the control circuit board controls the alarm device to release the alarm and/or the control circuit board controls the electric locking device to unlock the cover.

12. The electronic cigarette of claim 11, wherein the heating component is a heating cup, the temperature sensor is mounted on the bottom surface of the heating cup.

13. The electronic cigarette of claim 11, wherein the electric locking device is an electric plug lock, the electric locking device comprises a locking body and a locking member disposed at the locking body, the locking tongue can extend out of the lock body and can also be retracted from the outer side of the lock body into the lock body, the cover defines a locking hole for the locking member to be inserted into or withdrawn therefrom to lock or unlock the cover.

14. The electronic cigarette of claim 13, wherein the top surface of the main housing is provided with an atomizing component installation groove for mounting the atomizing assembly, the atomizing component installation groove comprises a first groove and a second groove located above the first groove two opposite sides of the second groove extends through the corresponding opposite sides of the main housing, an arcuate groove is laterally opened along the main housing on the inner wall of the another opposite sides of the groove top section, the locking hole is defined at bottom surface of the cover, the locking member is inserted into or withdrawn from the locking hole along a vertical direction of the main housing.

15. The electronic cigarette of claim 14, wherein the cover comprises a cover plate and a projection protruding from the bottom surface of the cover plate, the outer circumference of the projection is provided with a latch, the upper surface of the cover plate is provided with a smoke guiding passage corresponding to the position of the projection, the smoke guiding passage extends through the projection, the atomizing assembly comprises a filter screen, the filter screen is located in the atomizing component installation groove.

16. The electronic cigarette of claim 13, wherein when the cover is covered on the atomizing assembly, the peripheral side of the cover is at least partially embedded in the main housing, the locking hole is defined on one side surface of the cover, the locking member can be inserted into or withdrawn from the locking hole laterally along the main housing.

17. The electronic cigarette of claim 11, wherein the electric locking device is an electromagnetic lock, the electromagnetic lock comprises an electromagnet and a magnetic member, the main housing is provided with an electric locking device mounting groove, the cover is provided with a locking hole, the electromagnet is mounted in the electric locking device mounting groove, the magnetic member is located in the locking hole.

18. An electronic cigarette, comprising:
a main housing;
an atomizing assembly located in the main housing; and
a cover attached to the atomizing assembly, wherein
the electronic cigarette further comprises an electric locking device and/or alarm device, a temperature sensor, and a control circuit board, the atomizing assembly comprises a heating component, the heating portion of the heating component is made of a material having a temperature coefficient of resistance characteristic, the control circuit board pre-stores the safe temperature, a correspondence table between the resistance of the heating portion and the temperature of the heating component, the control circuit board is configured for detecting the resistance of the heating portion, and calculating the temperature of the heating component according to the correspondence relationship between the resistance of the heating portion and the temperature of the heating component, the control circuit board is also configured to determine the relationship between the temperature of the heating component and the safe temperature, and controlling the action of the electric lock device and/or the alarm device according to the judgment result;
when the temperature of the component to be cleaned is greater than the safe temperature, the control circuit board controls the alarm device to issue an alarm and/or the control circuit board controls the electric locking device to lock the cover;
When the temperature of the component to be cleaned is less than or equal to the safe temperature, the control circuit board controls the alarm device to release the alarm and/or the control circuit board controls the electric locking device to unlock the cover.

19. The electronic cigarette of claim 18, wherein the electric locking device is an electric plug lock, the electric locking device comprises a locking body and a locking member disposed at the locking body, the locking tongue can extend out of the lock body and can also be retracted from the outer side of the lock body into the lock body, the cover defines a locking hole for the locking member to be inserted into or withdrawn therefrom to lock or unlock the cover.

20. The electronic cigarette of claim 18, wherein the electric locking device is an electromagnetic lock, the electromagnetic lock comprises an electromagnet and a magnetic member, the main housing is provided with an electric locking device mounting groove, the cover is provided with a locking hole, the electromagnet is mounted in the electric locking device mounting groove, the magnetic member is located in the locking hole.
